(19) United States
(12) Patent Application Publication
(10) Pub. No.: US 2003/0113703 A1
(43) Pub. Date: Jun. 19, 2003

(54) Focusing educational process for a child

(76) Inventors: Thomas Whitney Strickland JR., Tallahassee, FL (US); Michael F. Zoda, Tallahassee, FL (US)

Correspondence Address: John Wiley Horton, Attorney, Pennington, Moore, Wilkinson, Bell & Dunbar, P.A., 2nd Floor, 215 S. Monroe St., Tallahassee, FL, 32301, US

(21) Appl. No.: 10/021,789

(22) Filed: Dec. 19, 2001

(51) Int. Cl. G09B 1/00; A47B 41/00

(52) U.S. Cl. 434/433

(57) ABSTRACT

A systematic training method for use with the ADD child. The method begins with the instructor explaining the meaning of focusing one's attention to the child. The child is required to remain immobile for a suitable period. Next, the child is conditioned to maintain eye contact with the instructor for a sustained period. Once these objectives have been met, a series of tasks are given to the child focusing on the child's ability to: (1) follow oral commands to carry out physical actions; (2) recall an oral series of 3 or 4 numbers, letters, or words; (3) recall an oral series of 4 or 5 numbers, letters, or words; (4) recall a written series of 3 or 4 numbers, letters, or words; (5) recall a written series of 4 or 5 numbers, letters, or words; and (6) recall a written series of 5 numbers, letters, or symbols using color variations for each.

Using these memory exercises as an evaluation tool, a step-wise methodology is employed to train the child to focus his or her attention. The inventors have assumed that different concentration techniques must be employed to (1) follow oral commands to perform physical acts; (2) recall and recite oral information; and (3) recall and recreate written information. The ability to perform well in each of these categories is essential to the child's success in school and ultimately to the child's success in life. Thus, these three processes are employed in the method disclosed.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of education. More specifically, the invention comprises a process whereby a child suffering from an inability to focus his or her attention can be trained to do so.

2. Description of the Related Art

In order to learn, a child must be able to focus his or her attention on a subject for a sufficient period of time. Some children are unable to do this. Many of these children are ultimately diagnosed with Attention Deficit Disorder (“ADD”), which may also be referred to as Attention Deficit Hyperactivity Disorder (“ADHD”).

A child with ADD is typically incapable of carrying out simple instructions due to an inability to focus on the instructions for a period sufficient to comprehend them. This deficiency often results in poor classroom performance and a general sense of frustration for the child. Typical observations for a child with ADD are as follows:

1. The child is extremely frustrated in the morning, often screaming and kicking even before leaving bed;

2. The child fights getting dressed;

3. The child is disobedient and obstinate prior to school;

4. The child will not look parents or instructors in the eyes;

5. The child has difficulty making even simple decisions, such as choosing a toy or treat;

6. After making a decision, the child often regrets the decision;

7. The child displays dramatic personality changes over the course of a day;

8. Teachers report a lack of concentration;

9. The child's grades range from the high to the low, with many on the low end;

10. The child's teachers suspect a mental processing problem;

11. The child misspells three and four letter words, even after reviewing;

12. In the child's schoolwork, entire sections of assignments or tests are left out;

13. The child is unable to read three short paragraphs without displaying frustration and resistance;

14. The child resists doing homework;

15. The child is vulnerable to even distant distractions, often verbalizing frustration at the slightest distraction;

16. The child fights going to sleep or taking a nap, and

17. The child's social interaction is often negative.

Children displaying these traits have traditionally been treated with drugs. The child will often be given these drugs from an early age (such as 6 or 7) through the late teen years. The goal is ultimately to wean the child from the drugs by adulthood. While they do address the problem, the long-term effects of these drugs are a concern. In addition, the child is never taught to regulate his or her own actions and to deal with the root cause of the problems.

The present invention seeks to produce the same results without the use of drugs. This result is accomplished by teaching the child:

1. What it means to focus;

2. How to narrow his or her field of focus by performing tasks of increasing complexity; and

3. New methods of learning once the ability to focus has been instilled.

### BRIEF SUMMARY OF THE INVENTION

The inventor's approach is to use a systematic training method with the ADD child. The method begins with the instructor explaining the meaning of focusing one's attention to the child. The child is required to remain immobile for a suitable period. Next, the child is conditioned to maintain eye contact with the instructor for a sustained period. Once these objectives have been met, a series of tasks are given to the child focusing on the child's ability to: (1) follow oral commands to carry out physical actions; (2) recall an oral series of 3 or 4 numbers, letters, or words; (3) recall an oral series of 4 or 5 numbers, letters, or words; (4) recall a written series of 3 or 4 numbers, letters, or words; (5) recall a written series of 4 or 5 numbers, letters, or words; and (6) recall a written series of 5 numbers, letters, or symbols using color variations for each.

Using these memory exercises as an evaluation tool, a step-wise methodology is employed to train the child to focus his or her attention. The inventor has assumed that different concentration techniques must be employed to (1) follow oral commands to perform physical acts; (2) recall and recite oral information; and (3) recall and recreate written information. The ability to perform well in each of these categories is essential to the child's success in school and ultimately to the child's success in life. Thus, these three processes are employed in the method disclosed.

### BRIEF DESCRIPTION OF THE SEVERAL VIEWS OF THE DRAWINGS

FIG. 1 is a flow chart, showing the first three stages of the process.

FIG. 2 is a flow chart, showing the next two stages of the process.

FIG. 3 is a flow chart, showing the next two stages of the process.

FIG. 4 is a flow chart, showing the next two stages of the process.

FIG. 5 is a flow chart, showing the final stage of the process.

### REFERENCE NUMERALS IN THE DRAWINGS

10 focusing explanation

12 immobilization step

14 eye contact drill

16 verbal correction

18 praise step

20 first task step

22 return to eye contact drill

24 praise step

26 extended eye contact drill

28 verbal correction

30 praise step

32 second task set

34 encouragement step

36 praise step

38 third task set

40 encouragement step

42 praise step

44 fourth task set

46 encouragement step

48 praise step

50 fifth task set

52 encouragement step

54 praise step

56 sixth task set

58 encouragement step

60 praise step

62 exercise completion

### DESCRIPTION OF THE INVENTION

The complete process will be described in detail prior to explaining how it is applied. The reader should bear in mind, however, that the child will not likely complete the entire process in a single sitting.

The reader should also bear in mind that the use of a mental health expert is highly recommended in the implementation of the process to be disclosed. It is critical to assign initial tasks which the child has a reasonable chance of successfully completing (providing the child concentrates). Thus, the advice of a mental health professional is often needed to determine a good starting level for the child.

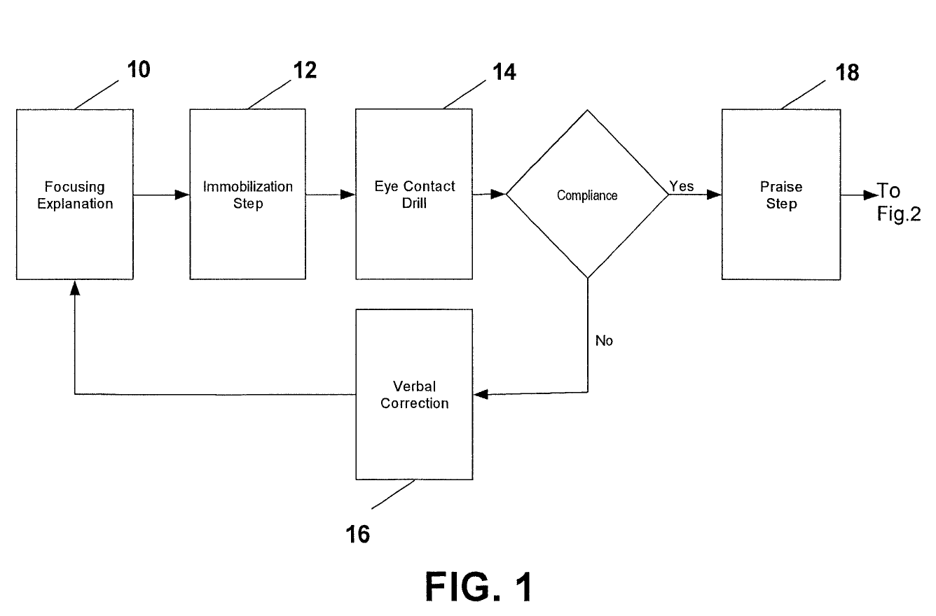

FIG. 1 is a flow chart illustrating how the process begins. An instructor sits down with the child, preferably directly facing the child across a table or desk. The instructor then verbally explains that focusing means the ability to think about only one thing. This step is shown as focusing explanation 10. Next, the instructor requires the child to remain immobile. The child is not allowed to move his or her hands or feet. This step is shown as immobilization step 12. Strict discipline must be enforced throughout the process, but particularly with this step.

The child is next required to look directly into the eyes of the instructor for a period of several seconds (eye contact drill 14). If the child looks away, the instructor abruptly and loudly stops the child by saying words such as “You looked away from me! You were focusing on something other than what I am talking about!” This is shown in FIG. 1 as verbal correction 16. If the child does look away, then following verbal correction 16, the process returns to focusing explanation 10 and begins again.

If, however, the child is able to comply with eye contact drill 14, the instructor moves on to praise step 18. The child must be rewarded with verbal praise for the completion of each step. The reader will note praise steps throughout the process. The inventor believes these steps to be crucial.

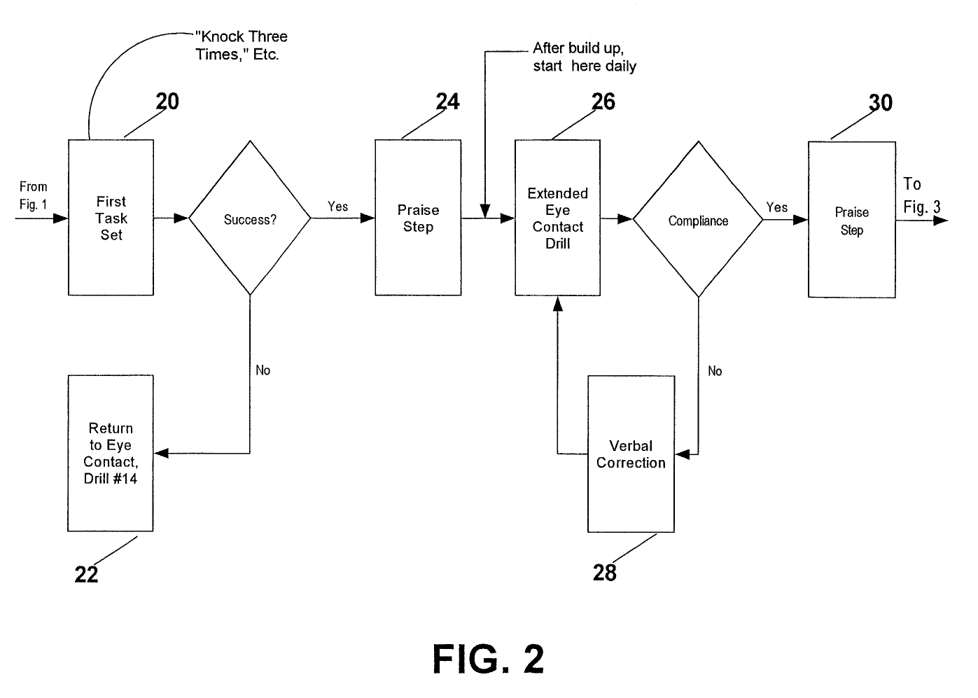

Turning now to FIG. 2—once praise step 18 is completed, the instructor gives the child a set of oral instructions to carry out physical tasks. This step, listed as first task set 20, might consist of the following: “(1) Go to the door; (2) Knock three times; (3) Return to me; (4) Stand in front of me and inform me that you have knocked on the door; (5) Go to the kitchen; (6) Return to me; (7) Stand in front of me and tell me you are finished.”

If the child is unable to complete first task set 20, then the instructor returns to eye contact drill 14 and begins again from there (shown as step 22 in the diagram). If, however, the child is successful, then a new set of instructions is given. Once the child has successfully executed at least two sets of instructions in a row, the process moves to praise step 24. At this point the child is again verbally rewarded for successfully completing the task.

It is important to remember that the ADD child finds it inherently difficult to follow instructions. The child must not be allowed to avoid completing first task set 20 by throwing a tantrum. The instructor must persist until praise step 24 is reached. However, some judgment in the creation of first task set 20 is needed. The instructor may realize that he or she has included too many steps for the child to follow in the child's present state. If so, the number or complexity of the steps required can be reduced to allow the child to succeed. The process disclosed builds on success, so it is essential that the child should experience some success early in the process.

Once praise step 24 is completed, the process moves on to extended eye contact drill 26. In this portion, the child is required to look the instructor directly in the eyes for 30 seconds. If the child looks away, then the process moves to verbal correction 28. At this point, the instructor attempts to identify what distracted the child. The instructor then explains to the child that it is not possible to focus on the instructor and the distraction at the same time. Following this explanation, the process moves back to extended eye contact drill 26.

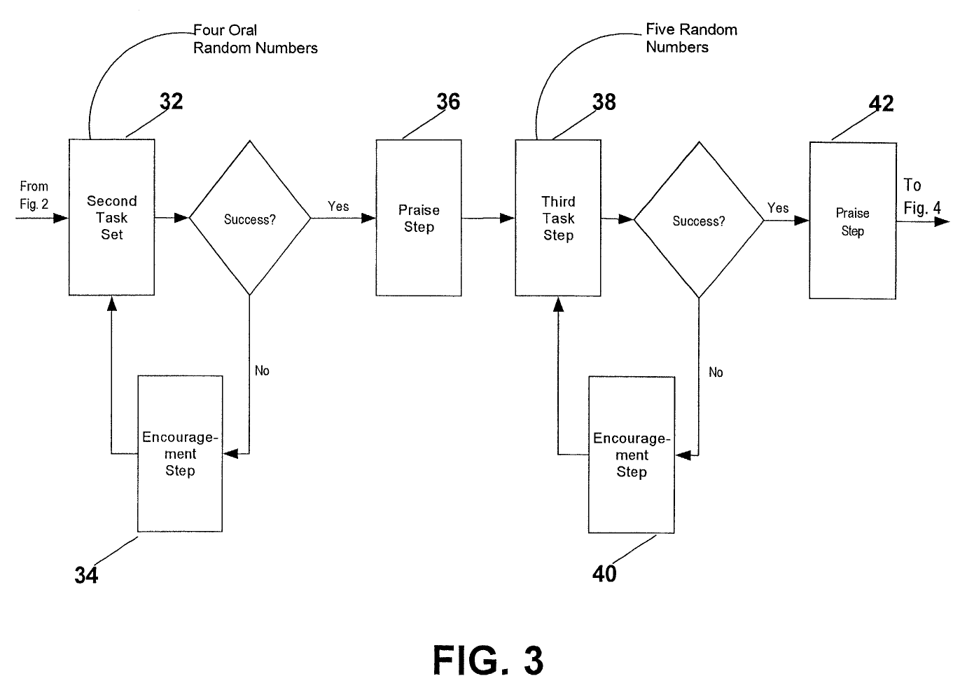

Once extended eye contact drill 26 has been successfully completed, the process moves to praise step 30. Turning now to FIG. 3, the instructor next assigns second task set 32. In this step, the instructor orally gives the child a series of 4 randomly selected numbers. Again—depending on the instructor's assessment of the child's ability—it may be necessary to start with only three numbers. Depending on the child's age, it may also be advantageous to use words or letter. The child is then asked to orally repeat the 4 numbers, words, or letters. This step requires the child to perform essentially 8 tasks—4 numbers in 4 correct locations in the sequence.

If the child is not successful, the process moves to encouragement step 34. The child is encouraged to continue trying. The child is not reprimanded for the inability to recall, so long as the child is attempting to comply. The instructor continues providing sets of random numbers (or words or letters) until the child successfully completes at least two sets in a row, at which point the process moves to praise step 36. Throughout this disclosure, a praise step simply indicates that the child is verbally rewarded for success. Likewise, an encouragement step means that the child is verbally encouraged to keep trying. The reader will observe that the flow chart only shows one pass through each task set in the event of success. The reader should appreciate, however, that the one successful pass may include at least two successful recitations of number sequences in a row. For purposes of visual simplicity, these multiple passes have not been illustrated in the drawing views.

After praise step 36, the instructor assigns third task set 38. This step again involves the instructor orally assigning a random sequence of numbers, letters, or words. (For the remainder of this explanation, the reader will understand that letters or words could be substituted for random numbers). However, the sequence is lengthened from second task set 32. Thus, if second task set 32 involved 4 random numbers, then third task set 38 would involve 5 random numbers. If the child is unable to successfully recite third task set 38, then the process moves to encouragement step 40 and then to a new set of random numbers, letters, or words. Once the child has successfully recited at least two third task sets 38, however, the process moves on to praise step 42.

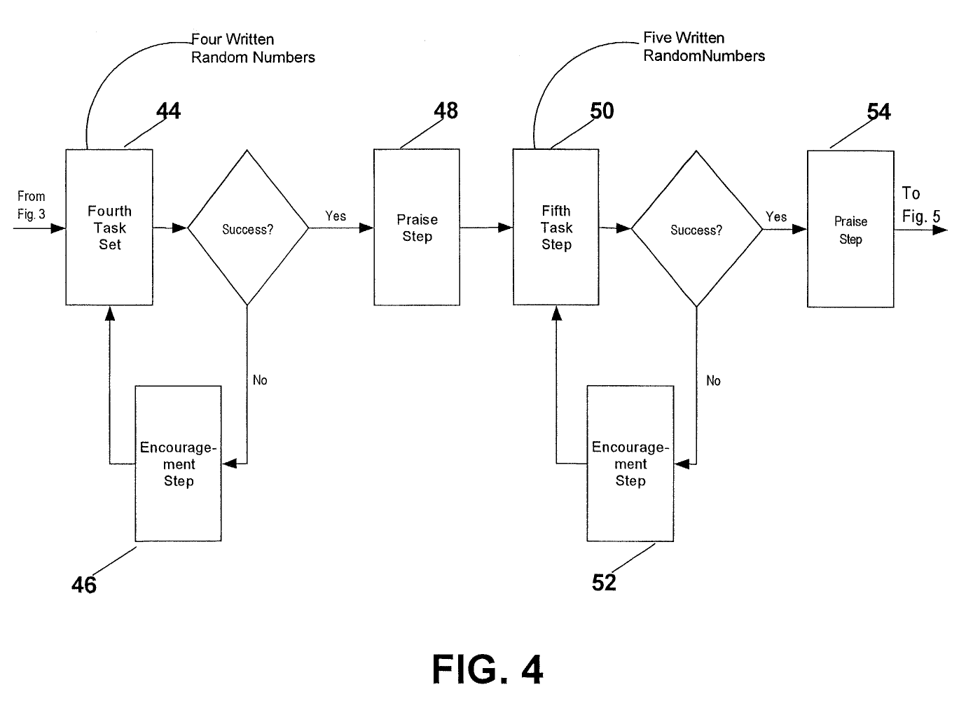

Turning now to FIG. 4, the details of fourth task set 44 will be explained. Prior to this point, all the instructions to the child have been oral. At this point in the process, the instructions shift to written ones. In fourth task set 44, the instructor writes a sequence of 4 random numbers on a sheet of paper and allows the child to study it for as long as desired. Once the child indicates he or she is ready to proceed, the instructor turns over the sheet of paper and asks the child to write the random sequence provided. If the child is unable to do so, the process moves to encouragement step 46. Fourth task set 44 is repeated until the child has successfully completed at least two sequences in a row. The process then moves to praise step 48.

Next comes fifth task set 50. At this point, the instructor writes a sequence of five random numbers and again allows the child to study these for as long as desired. The child is then asked to recreate the sequence once the paper has been turned over. A successful recreation results in praise step 54, while an unsuccessful one results in encouragement step 52. Again, once at least two successful recreations in a row have been completed, the process moves on—in this case to praise step 54.

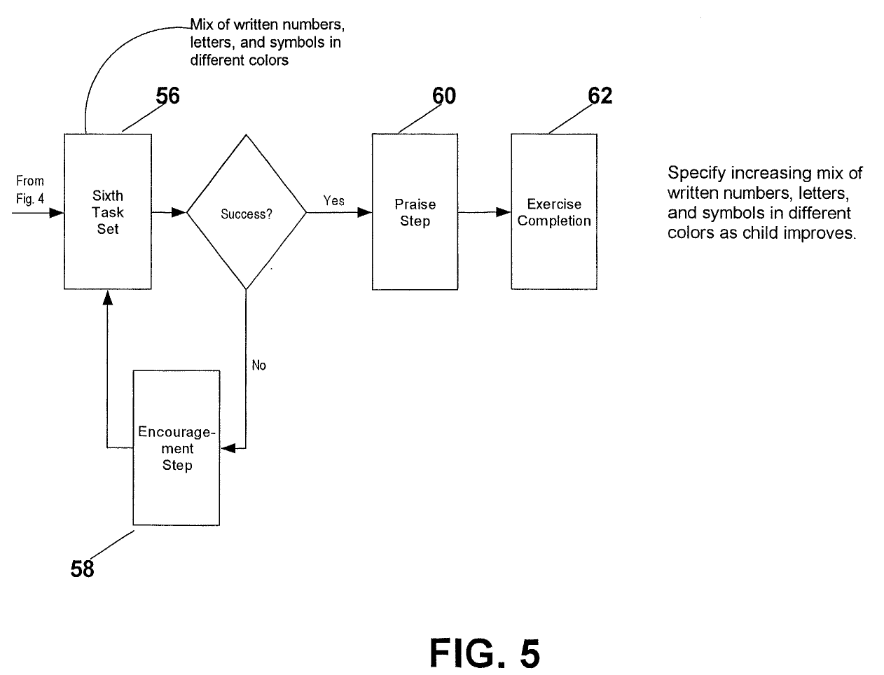

Turning now to FIG. 5, the instructor provides sixth task set 56. Sixth task set 56 adds two layers of complexity. First, it includes a mix of numbers, letters, and symbols. Second, it presents these numbers, letters, and symbols in different colors. As one example, the instructor might provide the following sixth task set 56: X (in blue), 9 (in red), + (in green), B (in black), and 7 (in orange). Thus, a 5-member sequence is provided using numbers, letters, and symbols in different colors.

The child is again allowed to study the sequence for as long as desired. The child is then asked to recreate the sequence exactly as it was presented (including the use of the correct colors). If the child is unsuccessful, the process moves to encouragement step 58. Once the child has successfully recreated at least two sequences in a row, the process moves to exercise completion 62.

The reader should understand that the instructor will not typically go through the entire process in a single sitting. Focusing explanation 10 through praise step 24 are often needed initially to teach the child how to pay attention to the instructor. After the first few days, however, it is often possible to begin the exercise with extended eye contact drill 26.

To be fully effective, the process must be repeated every day. The ADD child often awakens in an unfocused state. It is therefore advantageous to run through the process in the morning, shortly after the child awakens. It is also often necessary to run through the process when the child awakens from a nap.

Once the child has a good grounding in the process, the instructor would typically start with extended eye contact drill 26 and run through exercise completion 62. However, more complex task sets must often be added in order to keep the child challenged.

As an example, second task set 32 might be increased to 5 random numbers, third task set 38 to six random numbers and so on. The important thing is to keep the successive task sets increasing in complexity.

Once the process has been repeated for many days, the ability of an ADD child to properly recall and recite sequences will often improve dramatically. The inventor has found that a sequence of 13 numbers, letters, and symbols (in different colors) can ultimately be used for sixth task set 56.

Those skilled in the art will appreciate that the particular concentration and memory exercises employed are not critical. Rather, it is the methodical enforcement of concentration that produces the results. As an example, symbols could be substituted for numbers earlier in the process. Likewise, random physical actions could be employed.

The principal advantages of the invention are that it:

1. Does not rely on drugs;

2. Does not require specialized training on the instructor's part;

3. Does not require expensive equipment, such as computers, to perform; and

4. Can be performed practically anywhere.

Although the preceding description contains significant detail, it should not be construed as limiting the scope of the invention but rather as providing illustrations of the preferred embodiment of the invention. As an example, it was previously disclosed that the sequences given to the child could be comprised of random numbers, letters, words, or symbols. These may be generically denoted as “memory elements.” The inventors do not believe that the selection of one type of “memory element” over another—such as the use of random numbers rather than random words—is particularly significant to the process. Thus, it should be understood that one type of memory element may be readily substituted for another. However, as also disclosed previously, it is important to mix together different types of memory elements in the final stages of the process. If the process initiates with random numbers, then random letters and/or symbols would need to be introduced in the final stages.

Having described my invention, I claim:

1. A process which allows an instructor to teach a child to focus his or her attention, comprising:
a. explaining to said child what it means to focus one's attention;
b. requiring said child to remain immobile;
c. requiring said child to maintain eye contact with said instructor for a period prior to the commencement of instruction;
d. praising said child for maintaining said eye contact, once said eye contact is achieved;
e. orally reciting to said child a first task set, wherein said first task set includes a random set of instructions to carry out physical tasks;
f. requiring said child to successfully complete said first task set by physically carrying out said instructions in said first task set;
g. thereafter repeatedly giving said child another set of instructions to carry out physical tasks and requiring said child to carry out said instructions until said child is able to successfully complete at least two of said sets of instructions in a row; and
h. praising said child for successfully completing said at least two of said sets of instructions to carry out physical tasks in a row.

2. The process as recited in claim 1, further comprising:
a. requiring said child to maintain extended eye contact with said instructor for at least 20 seconds;
b. praising said child for maintaining said extended eye contact, once said extended eye contact is achieved;
c. orally reciting to said child a second task set, wherein said second task set includes a random sequence of at least three memory elements, wherein said memory elements are all of the same type;
d. requiring said child to successfully complete said second task set by orally reciting said random sequence of at least three memory elements;
e. thereafter repeatedly giving said child another random sequence of at least three memory elements and requiring said child to successfully recite said random sequence until said child is able to successfully recite at least two of said random sequences in a row; and
h. praising said child for successfully completing said at least two of said random sequences in a row.

3. The process as recited in claim 2, further comprising:
a. orally reciting to said child a third task set, wherein said third task set includes a random sequence of at least four memory elements, wherein said memory elements are all of the same type;
b. requiring said child to successfully complete said third task set by orally reciting said random sequence of at least four memory elements;
c. thereafter repeatedly giving said child another random sequence of at least four memory elements and requiring said child to successfully recite said random sequence until said child is able to successfully recite at least two of said random sequences in a row; and
d. praising said child for successfully completing said at least two of said random sequences in a row.

4. The process as recited in claim 3, further comprising:
a. presenting a fourth task set to said child in written form, wherein said fourth task set includes a random sequence of at least four memory elements, wherein said memory elements are all of the same type;
b. requiring said child to successfully complete said fourth task set by writing said random sequence of at least four memory elements;
c. thereafter repeatedly giving said child another random written sequence of at least four memory elements and requiring said child to successfully write said random sequence until said child is able to successfully write at least two of said random sequences in a row; and
d. praising said child for successfully completing said at least two of said random sequences in a row.

5. The process as recited in claim 4, further comprising:
a. presenting a fifth task set to said child in written form, wherein said fifth task set includes a random sequence of at least five memory elements;
b. requiring said child to successfully complete said fifth task set by writing said random sequence of at least five memory elements;
c. thereafter repeatedly giving said child another random written sequence of at least five memory elements and requiring said child to successfully write said random sequence until said child is able to successfully write at least two of said random sequences in a row; and
d. praising said child for successfully completing said at least two of said random sequences in a row.

6. The process as recited in claim 5, further comprising:
a. presenting a sixth task set to said child in written form, wherein said sixth task set includes a random sequence of at least five memory elements, wherein said random sequence is comprised of numbers, letters, and symbols, written in various colors;
b. requiring said child to successfully complete said sixth task set by recreating from memory, in written form, said random sequence of at least five memory elements written in various colors;
c. thereafter repeatedly giving said child another random written sequence of at least five memory elements written in various colors and requiring said child to successfully write said random sequence until said child is able to successfully write at least two of said random sequences in a row; and
d. praising said child for successfully completing said at least two of said random sequences in a row.

7. A process which allows an instructor to teach a child to focus his or her attention, comprising:
a. requiring said child to maintain extended eye contact with said instructor for at least 20 seconds;
b. praising said child for maintaining said extended eye contact, once said extended eye contact is achieved;
c. orally reciting to said child a second task set, wherein said second task set includes a random sequence of at least three memory elements, wherein said memory elements are all of the same type;
d. requiring said child to successfully complete said second task set by orally reciting said random sequence of at least three memory elements;
e. thereafter repeatedly giving said child another random sequence of at least three memory elements and requiring said child to successfully recite said random sequence until said child is able to successfully recite at least two of said random sequences in a row; and
f. praising said child for successfully completing said at least two of said random sequences in a row.

8. The process as recited in claim 7, further comprising:
a. orally reciting to said child a third task set, wherein said third task set includes a random sequence of at least four memory elements, wherein said memory elements are all of the same type;
b. requiring said child to successfully complete said third task set by orally reciting said random sequence of at least four memory elements;
c. thereafter repeatedly giving said child another random sequence of at least four memory elements and requiring said child to successfully recite said random sequence until said child is able to successfully recite at least two of said random sequences in a row; and
d. praising said child for successfully completing said at least two of said random sequences in a row.

9. The process as recited in claim 8, further comprising:
a. presenting a fourth task set to said child in written form, wherein said fourth task set includes a random sequence of at least four memory elements, wherein said memory elements are all of the same type;
b. requiring said child to successfully complete said fourth task set by writing said random sequence of at least four memory elements;
c. thereafter repeatedly giving said child another random written sequence of at least four memory elements and requiring said child to successfully write said random sequence until said child is able to successfully write at least two of said random sequences in a row; and
d. praising said child for successfully completing said at least two of said random sequences in a row.

10. The process as recited in claim 9, further comprising:
a. presenting a fifth task set to said child in written form, wherein said fifth task set includes a random sequence of at least five memory elements;
b. requiring said child to successfully complete said fifth task set by writing said random sequence of at least five memory elements;
c. thereafter repeatedly giving said child another random written sequence of at least five memory elements and requiring said child to successfully write said random sequence until said child is able to successfully write at least two of said random sequences in a row; and
d. praising said child for successfully completing said at least two of said random sequences in a row.

11. The process as recited in claim 10, further comprising:
a. presenting a sixth task set to said child in written form, wherein said sixth task set includes a random sequence of at least five memory elements, wherein said random sequence is comprised of numbers, letters, and symbols, written in various colors;
b. requiring said child to successfully complete said sixth task set by recreating from memory, in written form, said random sequence of at least five memory elements written in various colors;
c. thereafter repeatedly giving said child another random written sequence of at least five memory elements written in various colors and requiring said child to successfully write said random sequence until said child is able to successfully write at least two of said random sequences in a row; and
d. praising said child for successfully completing said at least two of said random sequences in a row.
